(19) United States
(12) Patent Application Publication
(10) Pub. No.: US 2018/0302826 A1
(43) Pub. Date: Oct. 18, 2018

(54) Automatic Management Of Pre-Configuration Levels For Autonomous UE Mobility

(71) Applicant: Nokia Technologies Oy, Espoo (FI)

(72) Inventors: Frank Frederiksen, Klarup (DK); Elena Virtej, Espoo (FI); Jari Petteri Lunden, Espoo (FI)

(73) Assignee: Nokia Technologies Oy

(21) Appl. No.: 15/489,916

(22) Filed: Apr. 18, 2017

(51) Int. Cl. H04W 36/00; H04W 76/04; H04W 36/04; H04W 74/08; H04W 8/02

(52) U.S. Cl. CPC H04W 36/0016; H04W 76/046; H04W 36/04; H04W 88/08; H04W 8/02; H04W 36/0077; H04W 74/0833

(57) ABSTRACT

In response to a request from a source cell, a target cell allocates resources for a user equipment (UE) to establish a connection with that target cell. The target cell sends to the source cell a) a set of RRC parameters that identify the allocated resources and b) an indication of a validity time the set of RRC parameters are valid for establishing the connection. The source cell sends the UE an autonomous user equipment mobility (AUM) configuration (including the set of RRC parameters) and an indication of a validity time during which the AUM configuration remains valid for establishing the connection with the target cell associated with that AUM configuration. The UE stores the AUM configuration and the validity time in its local memory, and utilizes the AUM configuration to establish a connection with the target cell only if the validity time is not expired.

### TECHNOLOGICAL FIELD

The described invention relates to wireless communications, and more particularly to configuring mobile terminal such as user equipments (UEs) for autonomous UE mobility for license-exempt radio environments.

### BACKGROUND

The volume of wireless communications has expanded greatly in recent years and conventional wireless systems have been re-examined to address future needs driven by a larger number of wireless users and a higher volume wireless data. One approach to do address these future needs is to expand the available radio spectrum by utilizing license exempt radio spectrum in new ways. Traditionally, IEEE 802.xx protocols have been dominant for utilizing wireless exempt radio spectrum over ranges larger than a personal area network (for example, about 10 meters for Bluetooth®) but there is ongoing research into utilizing more spectrum efficient radio access technologies such as for example E-UTRA, also known as LTE. Previously these conventional cellular radio access technologies have utilized license-exempt radio spectrum to offload some traffic while overall network control over the mobile terminal/UE itself was retained using the licensed radio bands but there are other stand-alone systems in which the UE operates autonomously in the license-exempt spectrum. An example of such a stand-alone system is known as MulteFire which utilizes LTE radio access technology on license-exempt (sometimes referred to as unlicensed) radio spectrum. Being a stand-alone system, the UE may also operate autonomously of the network infrastructure, meaning that in this case it is the UE that chooses if and when to handover and to which target cell it will do so. Of course, the Autonomous functionality of the UE (e.g. in autonomous UE handover) may happen if UE is pre-configured by network to do so. As a safe guard operation, also a network controlled handover could operate as a fallback-mode or vice-versa (i.e. a network controlled handover may also be a viable operation mode in an unlicensed frequency band as well). A research group called the MulteFire Alliance is working to make this concept a reality.

There are natural constraints when adapting UE mobility originally developed for licensed spectrum, in which the network tightly manages the individual UE's radio resource usage, for a license exempt radio environment in which neither the network nor the UE has ‘ownership’ of the radio spectrum. In a licensed radio environment the serving eNB can control the UE's mobility by directing a handover using radio resources that are guaranteed to be available for that handover and coordinated with a designed target eNB for that purpose. When the UE's mobility is autonomous in a license-exempt radio environment the serving eNB may not know exactly when the UE will handover nor the eNB that the UE may choose as its target eNB for that handover. In this regard the very term handover is no longer an action directed by the radio network. Similarly the target eNB may not know in advance that the UE has chosen it as the target eNB of the UE's handover.

FIG. 1 illustrates an example problem autonomous UE mobility presents. At the start the UE 10 has an active radio connection with the serving eNB 20S. The serving eNB 20S may sense a declining uplink signal strength from this UE 10 and from this it might anticipate the UE may soon need to handover, but the UE's mobility in this radio environment is configured to be in an autonomous manner, so the serving eNB 20S cannot direct such a handover. But for license exempt spectrum the UE may choose to relocate to another cell due to other reasons, for example the UE may consider the channel with the serving eNB 20S is too busy or there are insufficient signals for measuring the channel (e.g. due to high blocking of the channel, UE cannot detect receive/transmit in downlink/uplink). From the network's perspective the timing of a handover is more variable when the UE has autonomous mobility. In the FIG. 1 example there are two (or more) reasonable target eNBs for that UE 10, namely target eNB 20T1 and 20T2. The UE can choose either, and so in certain instances from the network's perspective the mobility target of a handover is more variable when the UE has autonomous mobility.

How much information should the serving eNB 20S provide to the autonomous mobility UE 10 in the radio environment of FIG. 1? From a radio spectrum efficiency perspective it ‘costs’ very little to provide the UE 10 with the cell ID and carrier frequencies of the neighbor eNBs, which the UE can use to more easily find system information and perform a random access procedure with the target eNB of its choosing. The most ‘expensive’ from that perspective is for the serving eNB to provide full radio resource control (RRC) configurations to the UE 10 for each available target eNB, due to both the signaling load and the fact this would have radio resources identified in those RRC configurations reserved at the target eNBs for that UE mobility. Between these is a partial RRC configuration, for example to an extent that would enable the UE to avoid reading system information for the target eNB and to perform a contention-free random access procedure but still requiring the UE to obtain certain dedicated RRC parameters from the target cell during the handover. Embodiments of these teachings address these inefficiencies when a UE has autonomous mobility, particularly when the radio environment is license-exempt spectrum.

### SUMMARY

According to a first aspect of these teachings there is a method comprising: in response to a request from a source cell, allocating resources for a user equipment (UE) to establish a connection with a target cell. Further in the method, a set of radio resource control (RRC) parameters that identify the allocated resources is sent to the source cell along with an indication of a validity time during which the set of RRC parameters remain valid for the UE to establish the connection.

According to a second aspect of these teachings there is an apparatus, such as a target radio access node or components thereof, comprising at least one computer readable memory storing computer program instructions and at least one processor. The computer readable memory with the computer program instructions is configured, with the at least one processor, to cause the apparatus to perform actions comprising: in response to a request from a source cell, allocate resources for a user equipment (UE) to establish a connection with a target cell; and send to the source cell a set of radio resource control (RRC) parameters that identify the allocated resources and an indication of a validity time during which the set of RRC parameters remain valid for the UE to establish the connection.

According to a third aspect of these teachings there is a computer readable memory storing computer program instructions that, when executed by one or more processors, cause an apparatus such as a target radio access node to perform actions that include: in response to a request from a source cell, allocating resources for a user equipment (UE) to establish a connection with a target cell; and sending to the source cell a set of radio resource control (RRC) parameters that identify the allocated resources and an indication of a validity time during which the set of RRC parameters remain valid for the UE to establish the connection.

According to a fourth aspect of these teachings there is a method comprising: receiving from a source cell an autonomous user equipment mobility (AUM) configuration and an indication of a validity time during which the AUM configuration remains valid for establishing a connection with a target cell associated with the AUM configuration; storing the AUM configuration and the validity time in a local memory of a user equipment (UE); and utilizing the AUM configuration to establish a connection with the target cell only if the validity time is not expired.

According to a fifth aspect of these teachings there is an apparatus, such as a user equipment (UE) or components thereof, comprising at least one computer readable memory storing computer program instructions and at least one processor. The computer readable memory with the computer program instructions is configured, with the at least one processor, to cause the apparatus to perform actions comprising: receive from a source cell an autonomous user equipment mobility (AUM) configuration and an indication of a validity time during which the AUM configuration remains valid for establishing a connection with a target cell associated with the AUM configuration; store the AUM configuration and the validity time in the at least one computer readable memory; and utilize the AUM configuration to establish a connection with the target cell only if the validity time is not expired.

According to a sixth aspect of these teachings there is a computer readable memory storing computer program instructions that, when executed by one or more processors, cause an apparatus such as a user equipment (UE) to perform actions that include: receiving from a source cell an autonomous user equipment mobility (AUM) configuration and an indication of a validity time during which the AUM configuration remains valid for establishing a connection with a target cell associated with the AUM configuration; storing the AUM configuration and the validity time in a local memory of a user equipment (UE); and utilizing the AUM configuration to establish a connection with the target cell only if the validity time is not expired.

### BRIEF DESCRIPTION OF THE DRAWINGS

FIG. 1 is a schematic diagram illustrating an example radio environment in which embodiments of these teachings may be practiced.

FIG. 2 is a signaling diagram illustrating automatic degradation of a RRC configuration for autonomous UE mobility, according to an embodiment of these teachings.

FIG. 3A is a process flow diagram illustrating a particular embodiment of these teachings from the perspective of the described target cell.

FIG. 3B is a process flow diagram illustrating a particular embodiment of these teachings from the perspective of the described user equipment.

FIG. 4 is a high level schematic block diagram showing further components of the source/target cells and UE that are suitable for practicing certain aspects of these teachings.

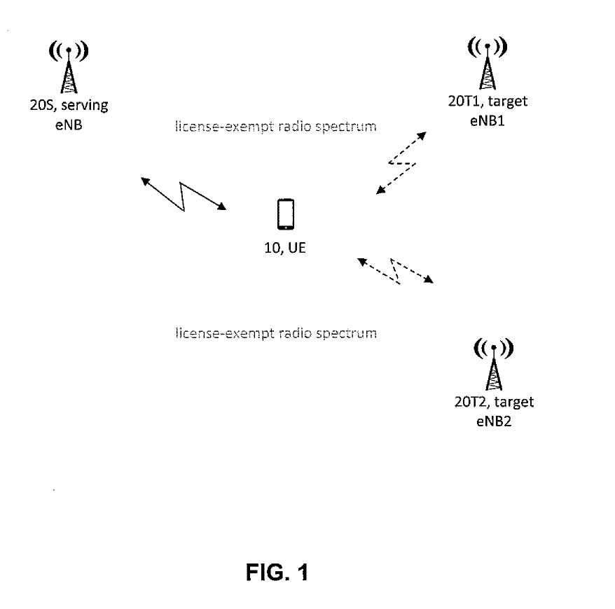

### DETAILED DESCRIPTION

The description below assumes a MulteFire system in which the radio access technology in use is LTE, and so the names of certain messages exchanged between the UE and an eNB reflect that radio access technology. This is not by way of limitation but to demonstrate a particularly detailed example deployment; these teachings are more broadly useful for radio environments in which the UE has autonomous mobility regardless of the specific radio access technology or message names being utilized. A similar approach could be utilized for example in 5G New Radio or 5G technologies or beyond that, so in any technology that would require a downgrading/changing in time of a configuration, due to being not applicable once some certain time has passed and the conditions could no longer apply. For example, this could be applied with 5G/new radio technology in mind for example in cases where during handover the target cell provides for source cell in a transparent container some information to be utilized during an e.g. a handover procedure by UE (could be either network controlled or autonomous type of handover)—but in which case the information provided by the target cell starts to expire and is no longer applicable, due to e.g. high channel blocking UE could not apply in time that particular configuration and most likely it is not applicable anymore as the condition changed.

By definition, using license-exempt radio bands (whether LTE radio access technology or otherwise) will cause uncertainty with regards to the UE's access to transmit on the radio channel, and this uncertainty is present for both downlink transmissions from the serving eNB 20S (which the UE needs for monitoring the radio link and for receiving data) and for the uplink transmissions from the TIE 10 (which the UE needs to transmit its measurement reports and data). When a UE starts experiencing a poor channel, this can be caused by either lack of coverage or by a lack of sufficient signals for measurements. The latter can occur when the radio channel is busy, and this will typically also mean the UE has difficulty in delivering to the serving eNB 20S its own normal measurement reports that would indicate that a neighboring cell might provide better conditions.

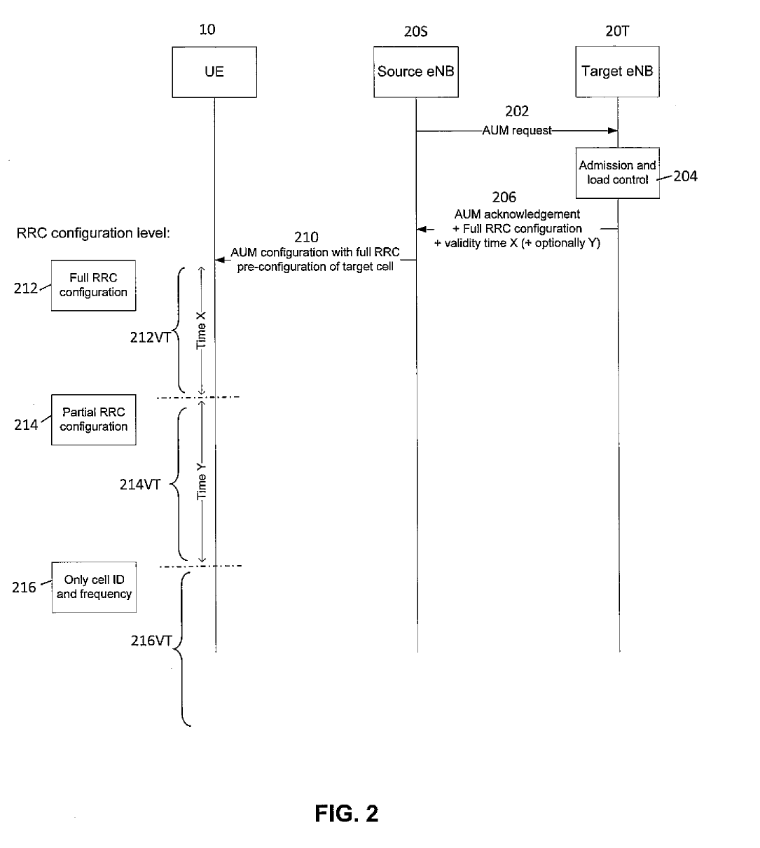

The background section above outlines three possible approaches distinguished for their relative spectrum efficiency. These can be considered as levels of pre-configuration of candidate target cells 20T1, 20T2 that the serving eNB 20S provides to the UE 10 in support of its autonomous UE mobility (AUM). The overarching purpose of such pre-configuration is for the network (the serving eNB 20S) to provide information to aid AUM devices 10 in autonomously connecting to neighboring cells in the event of for example the radio link failure or handover, and in general a greater amount of pre-configuration information enables a faster handover/re-connection. While it is the serving eNB 20S that provides this assistance information to the UE 10, as detailed below at FIG. 2 the serving/source eNB 20S initially may obtain this information from the individual neighboring/candidate target cell or cells 20T themselves. Those three different levels of pre-configuration the serving cell/eNB 20S may provide to the UE 10 can be distinguished as a) no RRC configuration for the target cell, b) partial RRC configuration and c) full RRC configuration.

In an example embodiment, the different levels of pre-configuration the serving cell/eNB 20S may provide to the UE 10 may be obtained/provided by target eNB/cell (for example in a transparent container).

In practice, no RRC configuration means the UE is given the minimum information of the target cell 20T1, 20T2, for example only cell ID and carrier frequency to enable the UE 10 to identify it. In this case, the UE 10 would need to do contention based random access procedure towards the target cell 20T1 or 20T2, after the UE 10 reads the system information (such as for example System Information Block Type MF1, or SIB-MF1). From the perspective of the serving eNB 20S the signaling overhead is low for no RRC configuration and preparation by the serving eNB 20S to send that signaling is fast. But from the perspective of the UE 10 there will be a delay in the handover/re-connection/re-establishment due to the length of time it will take the UE 10 to read the SIB-MF1, and to handover/re-connect/re-establish since a full (contention-based) random access procedure will need to be performed.

For a partial RRC configuration the serving eNB 20S provides to the UE 10 certain mobility control information (for example the MobilityControlInfo information element in LTE) which includes certain common resource configurations (for example the RadioResourceConfigCommon information element in LTE). In the partial RRC configuration case, the UE 10 does not have to read the system information broadcasted (SIB-MF1) by the target eNB 20T1 or 20T2, and depending on exactly what information is provided by the serving eNB 20S the UE 10 may be able to handover/re-connect/re-establish using a more abbreviated contention-free random access procedure. But still the UE 10 would need to obtain the remaining (dedicated) RRC parameters from the target cell 20T1 or 20T2 during the AUM handover procedure (for example, the parameters in the LTE RadioResourceConfigDedicated information element). With partial RRC configuration the AUM procedure is faster because reading the SIB can be avoided as well as some of the full (contention-based) random access procedure can be avoided by means of the contention-free random access.

For full RRC configuration the UE 10 is given the full RRC configuration for the target cell access. In this case the UE can do contention-free random access to the target cell 20T1 or 20T2 and does not need any further RRC reconfiguration from the target cell itself, so for example it can directly send its RRCReconfigurationComplete message to the target cell 20T1 or 20T2 once it establishes the connection with it. This option allows the fastest AUM procedure, but as mentioned above it is also the most ‘expensive’ option in terms of management since the serving eNB 20S would need to keep track of all the candidate AUM target cells and each UE would need to store all the RRC configurations for each of its candidate cells. Furthermore, when the serving eNB 20S (for example once it obtained from target cell/eNB the configuration) pre-configures a UE with such a full (target cell) RRC configuration, this reserves radio and other resources in the target cell such as for example radio network temporary identity (RNTI) and physical radio resources. Reserving those resources indefinitely would potentially be a problem.

In the AUM scenario the idea is to pre-configure UE with none, some or all of the RRC configuration of one or more potential AUM target cells 20T1, 20T2 before the configuration is actually needed. This is because at the time AUM is actually needed the serving (source) cell 20S may no longer be able to communicate with the UE 10, for example due to listen-before-transmit type delays in the license-exempt spectrum and/or low signal quality. The higher time variance for when a handover takes place in a AUM environment means the pre-configuration may need to be maintained for longer periods of time than in conventional licensed-spectrum scenarios, for example they may need to be kept for several seconds or even up to several minutes.

Embodiments of these teachings address the above considerations automatically handling the different levels of configuration without the need for active management via configuration/de-configuration. This improves the efficiency of radio resource utilization. More particularly, embodiments of these teachings impose a mechanism for automatic expiry control of RRC configurations for target cells such that the system will degrade autonomously as a function of perceived time. The following example described with respect to the signaling diagram of FIG. 2 illustrates this automatic degradation of the RRC configuration in the context of autonomous UE mobility. In FIG. 2 time progresses downward and signaling is shown horizontally between the illustrated entities.

Initially the UE 10 is established with a serving or source eNB 20S. For simplicity of explanation FIG. 2 shows only one target eNB 20T but in some cases there may be multiple target eNBs in which case the source eNB 20S can choose to get RRC configurations for only one of them, or more than one. The source eNB 20S sends a AUM request 202 to the target eNB 20T which in response performs admissions and load control 204 during which it reserves certain radio and other resources for AUM purposes. These resources are identified in the AUM acknowledgement message 206 which includes (in this example) a full RRC configuration the UE 10 can utilize for AUM to that particular target cell 20T, as well as a validity time X that indicates a time after which the RRC configuration is no longer valid. If we consider the full RRC configuration as a set of resources, the partial RRC configuration may be considered a subset of that set of full RRC configuration resources. In an embodiment the target eNB 20T also gives a validity time Y for that subset. The validity time may for example be expressed as an expiration time or as a duration and either of these may be in terms of chronological or radio time (such as an identified radio frame or number of radio frames during which the configuration is valid). In the case of two validity times X and Y the partial RRC configuration will always expire no earlier than the full RRC configuration, and preferably later as FIG. 2 illustrates. To this point in FIG. 2 the target eNB 20T has provided the RRC configuration(s) and the validity time(s) to the source eNB 20S.

Now at message 210 the source eNB 20S pre-configures the UE 10 with a full RRC configuration of the AUM target cell 20T. This configuration includes a validity time or times as above, which may be considered as a “best before” time or times since during the validity time the target eNB 20T has committed to honor that configuration but may still honor it afterwards.

The left of FIG. 2 shows different configuration levels for the UE 10 and their validity times once the UE 10 has received the AUM configuration message 210 from the source eNB 20S. Initially the full RRC configuration 212 is valid for the validity time X, identified as time 212VT in FIG. 2. In the embodiment of FIG. 2 there is a graceful and progressive diminishment over time of which configuration parameters remain valid. If the full RRC configuration is considered a set of parameters for AUM to a specific target cell 20T, the full set of parameters 212 are valid for a first validity time 212VT, then it can be considered that a subset of those parameters 214, less than the full set 212, forms the partial RRC configuration 214 that is valid for an additional validity time Y shown in FIG. 2 as time 214VT. Being a subset 214 of the full set 212, the parameters of the partial RRC configuration 214 are valid across both validity times 212VT and 214VT and so FIG. 2 shows the second validity time 214VT as additional to the first validity time 212VT.

After the first validity time 212VT expires and the UE 10 has not triggered autonomous mobility, the UE 10 automatically downgrades the pre-configuration from full RRC configuration 212 to partial RRC configuration 214. This means releasing those elements/parameters that are part of the full configuration 212 but that are not part of partial configuration 214. In some embodiments the AUM configuration message 210 can indicate specifically which elements/parameters are part of the full versus partial configuration. In other embodiments this division may be inherent and understood by both source eNB 20S and UE 10, for example where the partial RRC configuration 214 always has only the common resources; such an understanding absent signaling may be published in the governing radio standard protocols.

Upon expiry of the second validity time 214VT the partial RRC configuration 214 may is also no longer considered trusted, and at this point in time the UE 10 downgrades its RRC pre-configuration to no RRC configuration 216 which in the FIG. 2 illustration means the UE 10 retains only the cell ID and carrier frequency of the target cell 201 for relocating to it. Since the cell ID and carrier frequency are also parameters of the full 212 and partial 214 RRC configurations these may be considered a further subset 216 of the set 212 and of the subset 214, but cell ID and frequency/channel typically do not change often, but there may still be a validity time 216VT associated with this further subset 216 that includes only the parameters cell ID and carrier frequency. If so typically this third validity time 216VT will be much longer than either of the other two (for example, at least an order of magnitude longer), and after expiry of this third validity time 216VT the UE 10 is no longer allowed to do an autonomous handover towards this cell. In that case the UE 10 would have to fall back to a traditional cell search and cell reselection based on normal broadcast parameters the UE learns from monitoring system information.

Once the LIE 10 receives its pre-configuration via the AUM message 210 at time=zero, the UE 10 is configured with a full RRC configuration 212. At time=X which is expiry of the first validity time 212VT (the ‘best before’ time), if the UE has not yet performed AUM the UE autonomously downgrades itself to the partial RRC configuration 214. Autonomously in this regard means there is no further signalling needed from the network beyond the AUM configuration message 210. At time=Y which is expiry of the second validity time 214VT, if the UE has not yet performed AUM the UE autonomously downgrades itself to the no RRC configuration 216. At this time the UE 10 may no longer even “trust” the partial RRC configuration 214 and it will need to get further information on the RRC common configuration, for example from SIB-MF1.

In another alternative example embodiment the most complete RRC configuration by which the UE 10 is pre-configured is the partial RRC configuration. In this case FIG. 2 would be modified such that there is no full RRC configuration 212 at all. Once the LTE 10 receives its pre-configuration via the AUM message 210 at time=zero, the UE 10 is configured with partial RRC configuration 214. Then at expiry of the first validity time (the ‘best before’ time), if the UE has not yet performed AUM the UE autonomously downgrades itself to the no RRC configuration 216. Autonomously in this regard means there is no further signalling needed from the network beyond the AUM configuration message 210. At expiry of the second validity time, if the UE has not yet performed AUM the UE autonomously will need to get further information on the RRC common configuration, for example from SIB-MF1. In the adaptation to FIG. 2 for this embodiment, the first validity time 214VT would run from receipt of the AUM configuration message 210 at time=zero, 216VT would be the second validity time, and there would be no 212VT because there is no full RRC configuration 212 in this particular embodiment.

In another alternative example embodiment, UE 10 receives its pre-configuration via the AUM message 210 at time=zero, the UE 10 is configured with no RRC configuration. Then at expiry of the first validity time (the ‘best before’ time), if the UE has not yet performed AUM the UE will need to get further information on the RRC common configuration, for example from SIB-MF1. FIG. 2 would be adapted for this embodiment by removing the full 212 and partial 214 RRC configurations as well as their validity times 212VT and 214VT, leaving the validity time 216VT to run from receipt of the AUM configuration message 210 at time=zero.

In an example embodiment, the target eNB 20T indicates the source eNB 20S the validity time for the configuration so that the source eNB 20S knows when it should request to renew the configuration if still relevant (this may depend for example on measurement reports from the UE 10: is the target eNB 20T still a potential handover target, or has the UE 10 moved away from it). In this case the target eNB 20T pre-configuration given to UE 10 could be given with an associated expiry time (for example in terms of system frame number) of when the configuration is to be downgraded. Thus, avoiding timing inaccuracy caused by possible delays in transmitting the configuration to the UE.

One technical effect of the embodiment detailed above is that, beyond the AUM configuration message 210, it avoids further signaling for explicitly cancelling the pre-configuration, which would be a more costly procedure in terms of control signaling overhead. Releasing the pre-configuration in stages as FIG. 2 illustrates with the full 212 and partial 214 RRC configurations exploits the fact that certain relocation parameters, such as those common configuration parameters that are normally broadcast in system information, typically have longer validity time than dedicated resources which the target cell 20T is willing or able to reserve in response to the source cell's 20S AUM request 202. The full 212 and partial 214 RRC configurations enable the UE to re-locate to the target cell 20T faster as compared to reading the target cell's 20T full system information block and in some cases even performing a cell search to find that system information. Another technical effect of these teachings is that downgrading the pre-configuration avoids unnecessarily long reservation of dedicated radio resources in the target cell 20T, and relatedly this downgrading reduces the risk of the UE 10 attempting to use an outdated configuration for accessing the target cell 20T.

The examples above have the split between full 212 and partial 214 RRC configurations at the distinction between dedicated and common resources (that is, common+dedicated configuration for the full configuration 212, and only common configuration for the partial 214 configuration). This is only a non-limiting example and in other deployments and embodiments there may be a different division between full 212 and partial 214 RRC configurations. As an alternative example, the partial RRC configuration 214 could include the dedicated random access configuration to allow the UE 10 to perform contention free random access.

In some embodiments the specific parameters/elements that are released/invalidated at the automatic downgrading which occurs at expiry of the first validity time 212VT can be fixed by a published specification for the radio access technology in use, or as mentioned above they can be specifically indicated by the AUM configuration message 210 itself. In one particular embodiment the use of non-contention based random access resources could be constrained to a certain time interval, and in case the time limit for this expires, the UE should use contention based random access resources. For example, in different embodiments the interval during which the non-contention based random access resources are reserved/valid may expire at the end of first validity time 212VT, or at the end of the second validity time 212VT, depending on how long the target eNB 20T keeps those resources reserved for the UE 10.

As can be seen from FIG. 2, different communication devices implement different portions of these teachings. In the current example, the idea is described related to a UE 10 receiving configuration from a potential target eNB 20T, but the idea can in principle be implemented also e.g. between different network elements. For example, between two different network nodes where one eNB provides information to another on a given configuration that is going to be guaranteed to be valid for a certain amount of time. In our example case, this aspect is implemented between the source cell 20S and target cell 20T, in which the target eNB 20T provides information to the source eNB 20S on a given configuration that is going to be guaranteed to be valid for a certain amount of time. Another case is from a source eNB 20S to UE 10. In our case, this example is illustrated and explained as from the source eNB 20S to the UE 10; for example when configuring specific resources that are going to be limited in time (unless they are “renewed”). An example of this is where the target eNB 20T temporarily grants to the UE 10 (via the source cell 20S) certain uplink resources that the UE 10 may be using for autonomous transmissions (such as for grantless uplink transmissions). In this case the UE 10 may be configured such that its configured resources are only available for a few second unless renewed with a further allocation.

The above-described ‘degradation’ in time of the RRC configuration avoids the need for actively (via signalling) cancelling/managing the UE's configuration later, and as with the FIG. 2 example this enables the possibility to have a different expiry times for common and dedicated configurations. The expiry time or times can be implemented as a “label” with the RRC configuration in the AUM configuration message 210 where the new label indicates the “best before” time for the allocated resources.

The above are non-limiting examples of the broader teachings herein. In one variation there are no dedicated resources and the UE 10 receives only a partial RRC configuration 214 in the AUM configuration message 210. The validity time 214VT in this case may be standardized and published in a radio standard protocol, or it may be included in the AUM message 210 as in the more detailed FIG. 2 example. In this embodiment the UE 10 would not be pre-configured with a full RRC configuration at all but would need to obtain the dedicated parameters (or whatever other parameters are not included in the partial RRC configuration) from the target cell 20T itself, and would revert to the basic configuration level 216 (only cell ID and frequency) upon expiry of the validity time 214VT for that partial RRC configuration that it did receive if the UE 10 does not perform AUM prior to that expiry.

Also as noted above, MulteFire is only an example radio environment in which these teachings can be deployed to advantage. Other radio access technology systems employ the AUM concept, including recent iterations of LTE as well as the new radio (NR) being developed by the 3GPP organization that is sometimes referred to as 5G. Some early deployments of 5G are anticipated to be tied to LTE infrastructure before the 5G core network is deployed and such a hybrid LTE-5G network is anticipated to also utilize AUM concepts.

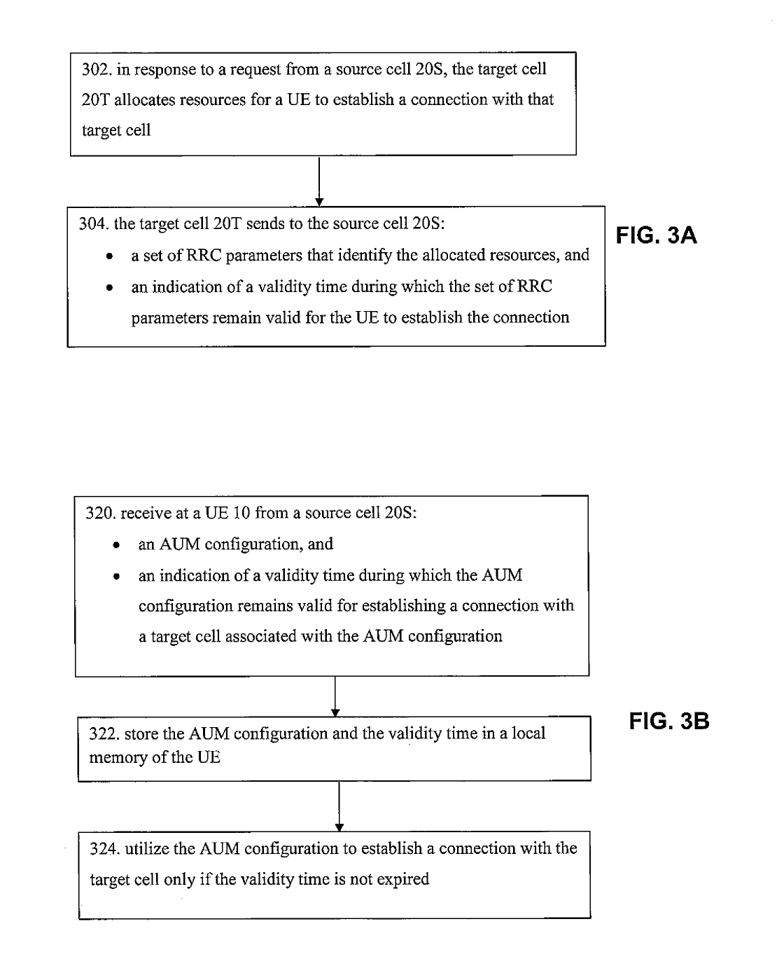

FIG. 3A is a process flow diagram illustrating a particular embodiment of these teachings from the perspective of the described target cell. At block 302 in response to a request from a source cell 20S, the target cell 20T allocates resources for a user equipment (UE) to establish a connection with that same target cell 20T. This is the admission and load control block 204 in response to the AUM request 202 at FIG. 2. Then at block 304 the target cell 20T sends to the source cell 20S a) a set of radio resource control (RRC) parameters that identify the allocated resources and b) an indication of a validity time during which the set of RRC parameters remain valid for the UE to establish the connection. This is shown at FIG. 2 as the AUM acknowledgement message 206. As described above, the set of RRC parameters at block 304 can in some embodiments be a full RRC configuration while in others where the UE 10 is not pre-configured with a full RRC configuration this may be only a partial RRC configuration.

In a particular embodiment the validity time of block 304 is a first validity time 212VT and the target cell 20T further sends to the source cell 20S an indication of a second validity time 214VT during which a subset of the set of RRC parameters remain valid for the UE to establish the connection. In this case the second validity time is different from the first validity time and the subset is less than the set. For example, the full set can be the full set of RRC configuration parameters 212 by which the LIE can establish the connection with the target cell 20T using a contention-free random access procedure in the absence of obtaining from the target cell 20T any further RRC configuration, and the subset 214 of the set of RRC parameters can includes more than only an identifier of the target cell and a frequency or channel for establishing the connection with the target cell 20T.

In another particular embodiment described more fully above, the set 212 of RRC parameters includes dedicated resources allocated by the target cell for the UE for the first validity time; and the subset 214 of the set of RRC parameters does not include any dedicated resources. Combined with this embodiment or separately, the target cell 20T can further send to the source cell 20S a third validity time 216VT during which a further subset 216 of the subset of the set of RRC parameters remain valid for the UE to establish the connection. In this embodiment the third validity time 216VT is different from the second validity time 216VT, the further subset 216 is less than the subset 214, and the further subset 216 includes only an identifier of the target cell and a frequency or channel for establishing the connection with the target cell 20T.

FIG. 3B is a process flow diagram illustrating a particular embodiment of these teachings from the perspective of the described user equipment. At block 320 the UE receives from a source cell 20S a) an autonomous user equipment mobility (AUM) configuration and b) an indication of a validity time during which the AUM configuration remains valid for establishing a connection with a target cell associated with the AUM configuration. FIG. 2 shows this as the AUM configuration message 210. The UE then stores the AUM configuration and the validity time in its local memory at block 322, and at block 324 the UE utilizes that stored AUM configuration to establish a connection with the target cell 20T only if the validity time is not expired. Similar to the detail above for block 304 of FIG. 3A, the AUM configuration at block 324 of FIG. 3B can in some embodiments be a full RRC configuration, in other embodiments where the UE 10 is not pre-configured with a full RRC configuration this AUM configuration may be only a partial RRC configuration, and in certain embodiments where the UE 10 is not pre-configured with either a full or partial RRC configuration this AUM configuration may be only the cell ID and frequency which the UE uses to identify the neighboring/target cell 20T.

In a particular embodiment the AUM configuration comprises a full set 212 of RRC configuration parameters by which the UE can establish the connection with the target cell 20T using a contention-free random access procedure in the absence of obtaining from the target cell 20T any further RRC configuration.

In the embodiment immediately above or separate from it, further detail for FIG. 3B may also have the validity time of block 320 as a first validity time 212VT and the UE further receives from the source cell 20S an indication of a second validity time 214VT, different from the first validity time 212VT, that indicates when a subset 214 of the full set 212 of RRC configuration parameters remains valid for establishing the connection with the target cell 20T. In this case also the subset 214 is less than the full set 212 of RRC configuration parameters. In a particular implementation the AUM configuration of block 320, the first validity time of block 320 and the second validity time mentioned above are received in an AUM configuration message (210 of FIG. 2) which distinguishes the RRC configuration parameters that are associated with the first validity time 212VT from the RRC configuration parameters that are associated with the second validity time 214VT. There are a variety of ways to so distinguish when such parameters are signalled, for example the order of their signalling, using the first validity time to separate the parameters in the message 210, and so forth. In one very specific implementation detailed above the subset 214 of the full set 212 of RRC configuration parameters does not include any dedicated resources and it also does include more than only an identifier of the target cell and a frequency or channel for establishing the connection with the target cell 20T.

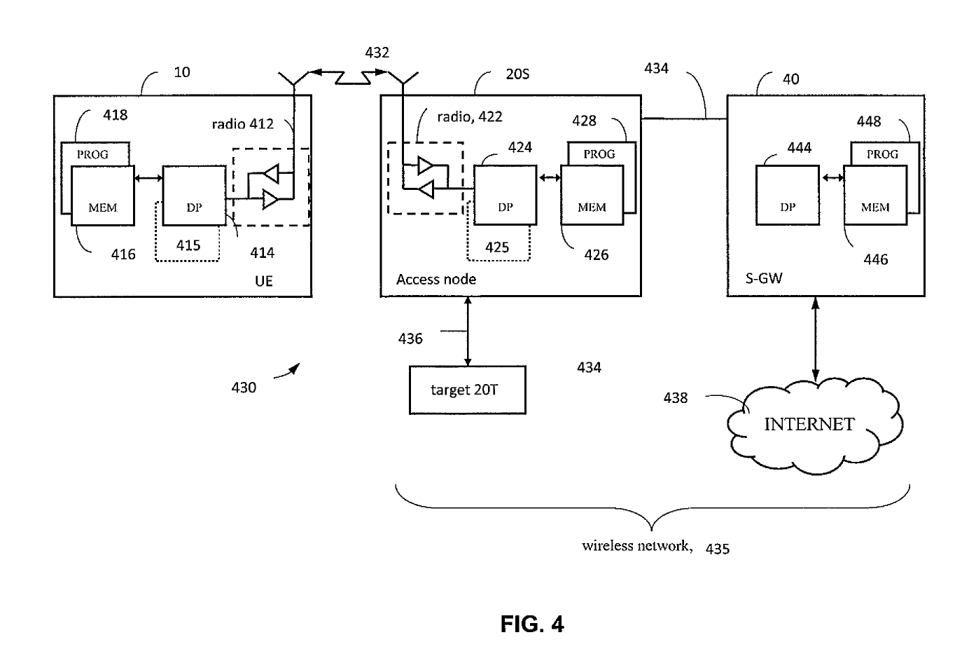

FIG. 4 is a high level diagram illustrating some relevant components of various communication entities that may implement various portions of these teachings, including a source base station identified generally as a source radio network access node 20S, a serving gateway (S-GW) 40 which may be co-located with a mobility management entity (MME), a user equipment (UE) 10, and a target cell 20T. In the wireless system 430 of FIG. 4 a communications network 435 is adapted for communication over a wireless link 432 with an apparatus, such as a mobile communication device which may be referred to as a UE 10, via a source radio network access node 20S. The network 435 may include a S-GW 40 that provides connectivity with other and/or broader networks such as a publicly switched telephone network and/or a data communications network (e.g., the internet 438).

The UE 10 includes a controller, such as a computer or a data processor (DP) 414 (or multiple ones of them), a computer-readable memory medium embodied as a memory (MEM) 416 (or more generally a non-transitory program storage device) that stores a program of computer instructions (PROG) 418, and a suitable wireless interface, such as radio frequency (RF) transceiver or more generically a radio 412, for bidirectional wireless communications with the source radio network access node 20S via one or more antennas. In general terms the UE 10 can be considered a machine that reads the MEM/non-transitory program storage device and that executes the computer program code or executable program of instructions stored thereon. While each entity of FIG. 4 is shown as having one MEM, in practice each may have multiple discrete memory devices and the relevant algorithm(s) and executable instructions/program code may be stored on one or across several such memories.

In general, the various embodiments of the UE 10 can include, but are not limited to, mobile user equipments or devices, cellular telephones, smartphones, wireless terminals, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The source radio network access node 20S also includes a controller, such as a computer or a data processor (DP) 424 (or multiple ones of them), a computer-readable memory medium embodied as a memory (MEM) 426 that stores a program of computer instructions (FROG) 428, and a suitable wireless interface, such as a RF transceiver or radio 422, for communication with the UE 10 via one or more antennas. The source radio network access node 20S is coupled via a data/control path 434 to the S-GW 40. The path 434 may be implemented as an S1 interface.

The source radio network access node 20S may also be coupled to other radio network access nodes such as the illustrated target radio network access node 20T via data/control path 436, which may be implemented as an X5 interface. At the level of detail shown at FIG. 4 the target radio network access node 20T has components substantially similar to those detailed above for the source radio network access node 20S, and will not be repeated therefor.

The S-GW 440 includes a controller, such as a computer or a data processor (DP) 444 (or multiple ones of them), a computer-readable memory medium embodied as a memory (MEM) 446 that stores a program of computer instructions (PROG) 448.

At least one of the PROGs 418, 428 is assumed to include program instructions that, when executed by the associated one or more DPs, enable the device to operate in accordance with exemplary embodiments of this invention. That is, various exemplary embodiments of this invention may be implemented at least in part by computer software executable by the DP 414 of the UE 10; and/or by the DP 424 of the source/target radio network access nodes 20S/20T; and/or by hardware, or by a combination of software and hardware (and firmware).

For the purposes of describing various exemplary embodiments in accordance with this invention the UE 10 and the source/target radio network access nodes 20S/20T may also include dedicated processors 415 and 425 respectively.

The computer readable MEMs 416, 426 and 446 may be of any memory device type suitable to the local technical environment and may be implemented using any suitable data storage technology, such as semiconductor based memory devices, flash memory, magnetic memory devices and systems, optical memory devices and systems, fixed memory and removable memory. The DPs 414, 424 and 444 may be of any type suitable to the local technical environment, and may include one or more of general purpose computers, special purpose computers, microprocessors, digital signal processors (DSPs) and processors based on a multicore processor architecture, as non-limiting examples. The wireless interfaces (e.g., RF transceivers 412 and 422) may be of any type suitable to the local technical environment and may be implemented using any suitable communication technology such as individual transmitters, receivers, transceivers or a combination of such components.

A computer readable medium may be a computer readable signal medium or a non-transitory computer readable storage medium/memory. A non-transitory computer readable storage medium/memory does not include propagating signals and may be, for example, but not limited to, an electronic, magnetic, optical, electromagnetic, infrared, or semiconductor system, apparatus, or device, or any suitable combination of the foregoing. Computer readable memory is non-transitory because propagating mediums such as carrier waves are memoryless. More specific examples (a non-exhaustive list) of the computer readable storage medium/memory would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

A communications system and/or a network node/base station may comprise a network node or other network elements implemented as a server, host or node operationally coupled to a remote radio head. At least some core functions may be carried out as software run in a server (which could be in the cloud) and implemented with network node functionalities in a similar fashion as much as possible (taking latency restrictions into consideration). This is called network virtualization. “Distribution of work” may be based on a division of operations to those which can be run in the cloud, and those which have to be run in the proximity for the sake of latency requirements. In macro cell/small cell networks, the “distribution of work” may also differ between a macro cell node and small cell nodes. Network virtualization may comprise the process of combining hardware and software network resources and network functionality into a single, software-based administrative entity, a virtual network. Network virtualization may involve platform virtualization, often combined with resource virtualization. Network virtualization may be categorized as either external, combining many networks, or parts of networks, into a virtual unit, or internal, providing network-like functionality to the software containers on a single system.

The following abbreviations that may be found in the specification and/or the drawing figures are defined as follows:

3GPP Third Generation Partnership Project

AUM autonomous UE mobility

E-UTRAN evolved UMTS radio access network

HO handover

LTE long term evolution (of E-UTRAN)

RRC radio resource control

SIB-MF1 system information block-MulteFire 1

UE user equipment

UMTS universal mobile telecommunications service

1. A method comprising:
in response to a request from a source cell, allocating resources for a user equipment (UE) to establish a connection with a target cell; and
sending to the source cell a set of radio resource control (RRC) parameters that identify the allocated resources and an indication of a validity time during which the set of RRC parameters remain valid for the UE to establish the connection.

2. The method according to claim 1, wherein the validity time is a first validity time and the method further comprises:
sending to the source cell an indication of a second validity time during which a subset of the set of RRC parameters remain valid for the UE to establish the connection;
wherein the second validity time is different from the first validity time and the subset is less than the set.

3. The method according to claim 2, wherein:
the set of RRC parameters comprises a full set of RRC configuration parameters by which the UE can establish the connection with the target cell using a contention-free random access procedure in the absence of obtaining from the target cell a further RRC configuration.

4. The method according to claim 3, wherein the subset of the set of RRC parameters includes more than only an identifier of the target cell and a frequency or channel for establishing the connection with the target cell.

5. The method according to claim 2, wherein:
the set of RRC parameters includes dedicated resources allocated by the target cell for the UE for the first validity time; and
the subset of the set of RRC parameters does not include any dedicated resources.

6. The method according to claim 2, the method further comprises:
sending to the source cell a third validity time during which a further subset of the subset of the set of RRC parameters remain valid for the UE to establish the connection;
wherein the third validity time is different from the second validity time, the further subset is less than the subset, and the further subset includes only an identifier of the target cell and a frequency or channel for establishing the connection with the target cell.

7. An apparatus comprising:
at least one computer readable memory storing computer program instructions; and
at least one processor;
wherein the computer readable memory with the computer program instructions is configured, with the at least one processor, to cause the apparatus to perform actions comprising:
in response to a request from a source cell, allocate resources for a user equipment (UE) to establish a connection with a target cell; and
send to the source cell a set of radio resource control (RRC) parameters that identify the allocated resources and an indication of a validity time during which the set of RRC parameters remain valid for the UE to establish the connection.

8. The apparatus according to claim 1, wherein the validity time is a first validity time and the actions further comprise:
send to the source cell an indication of a second validity time during which a subset of the set of RRC parameters remain valid for the UE to establish the connection;
wherein the second validity time is different from the first validity time and the subset is less than the set.

9. The apparatus according to claim 8, wherein:
the set of RRC parameters comprises a full set of RRC configuration parameters by which the UE can establish the connection with the target cell using a contention-free random access procedure in the absence of obtaining from the target cell a further RRC configuration.

10. The apparatus according to claim 9, wherein the subset of the set of RRC parameters includes more than only an identifier of the target cell and a frequency or channel for establishing the connection with the target cell.

11. The apparatus according to claim 8, wherein:
the set of RRC parameters includes dedicated resources allocated by the target cell for the UE for the first validity time; and
the subset of the set of RRC parameters does not include any dedicated resources.

12. The apparatus according to claim 8, the actions further comprising:
send to the source cell a third validity time during which a further subset of the subset of the set of RRC parameters remain valid for the UE to establish the connection;
wherein the third validity time is different from the second validity time, the further subset is less than the subset, and the further subset includes only an identifier of the target cell and a frequency or channel for establishing the connection with the target cell.

13-18. (canceled)

19. A method comprising:
receiving from a source cell an autonomous user equipment mobility (AUM) configuration and an indication of a validity time during which the AUM configuration remains valid for establishing a connection with a target cell associated with the AUM configuration;
storing the AUM configuration and the validity time in a local memory of a user equipment (UE); and
utilizing the AUM configuration to establish a connection with the target cell only if the validity time is not expired.

20. The method according to claim 19, wherein the AUM configuration comprises a full set of RRC configuration parameters by which the UE can establish the connection with the target cell using a contention-free random access procedure in the absence of obtaining from the target cell a further RRC configuration.

21. The method according to claim 20, wherein validity time is a first validity time and the method further comprises receiving from the source cell an indication of a second validity time, different from the first validity time, that indicates when a subset of the full set of RRC configuration parameters remains valid for establishing the connection with the target cell, wherein the subset is less than the full set of RRC configuration parameters.

22. The method according to claim 21, wherein the AUM configuration, the first validity time and the second validity time are received in a AUM configuration message which distinguishes the RRC configuration parameters that are associated with the first validity time from the RRC configuration parameters that are associated with the second validity time.

23. The method according to claim 21, wherein the subset of the full set of RRC configuration parameters does not include any dedicated resources and does include more than only an identifier of the target cell and a frequency or channel for establishing the connection with the target cell.

24. An apparatus comprising:
at least one computer readable memory storing computer program instructions; and
at least one processor;
wherein the computer readable memory with the computer program instructions is configured, with the at least one processor, to cause the apparatus to perform actions comprising:
receive from a source cell an autonomous user equipment mobility (AUM) configuration and an indication of a validity time during which the AUM configuration remains valid for establishing a connection with a target cell associated with the AUM configuration;
store the AUM configuration and the validity time in a local memory of a user equipment (UE); and
utilize the AUM configuration to establish a connection with the target cell only if the validity time is not expired.

25. The apparatus according to claim 24, wherein the AUM configuration comprises a full set of RRC configuration parameters by which the UE can establish the connection with the target cell using a contention-free random access procedure in the absence of obtaining from the target cell a further RRC configuration.

26. The apparatus according to claim 25, wherein validity time is a first validity time and the actions further comprise: receive from the source cell an indication of a second validity time, different from the first validity time, that indicates when a subset of the full set of RRC configuration parameters remains valid for establishing the connection with the target cell, wherein the subset is less than the full set of RRC configuration parameters.

27. The apparatus according to claim 26, wherein the AUM configuration, the first validity time and the second validity time are received in a AUM configuration message which distinguishes the RRC configuration parameters that are associated with the first validity time from the RRC configuration parameters that are associated with the second validity time.

28. The apparatus according to claim 26, wherein the subset of the full set of RRC configuration parameters does not include any dedicated resources and does include more than only an identifier of the target cell and a frequency or channel for establishing the connection with the target cell.

29-33. (canceled)
